(19) United States
(12) Patent Application Publication
(10) Pub. No.: US 2026/0291958 A1
(43) Pub. Date: Sep. 24, 2026

(54) DETECTING COMMAND AND CONTROL (C2) CHANNELS USING DOMAIN NAME SYSTEM (DNS) SERVERS

(71) Applicant: Royal Bank of Canada, Toronto (CA)

(72) Inventors: Sajeed Bakht, Toronto (CA); Nariman Mammadli, Toronto (CA); Adam Hulcoop, Toronto (CA)

(21) Appl. No.: 19/572,304

(22) Filed: Mar. 19, 2026

Related U.S. Application Data
(60) Provisional application No. 63/774,258, filed on Mar. 19, 2025.

(51) Int. Cl. H04L 9/40

(52) U.S. Cl. CPC H04L 63/1416

(57) ABSTRACT

A computer-implemented method for detecting a potential C2 channel traversing a DNS server comprises classifying DNS queries as either benign or potentially malicious, where a classification as potentially malicious occurs where part of the DNS query is suspected to be encoded (e.g. encrypted). Preferably the classification of the DNS queries is performed by a trained machine learning engine. A rule-based heuristic may compare the number of potentially malicious DNS queries emanating from a particular single host for a particular single domain to a threshold to assess whether the host is potentially infected. A method for training the machine learning engine comprises generating synthetic benign substrings by concatenating a plurality of dictionary words, generating synthetic encoded substrings by applying encoding to unencoded character strings, and training the machine learning engine to distinguish between the benign substrings and the encoded substrings.

### CROSS-REFERENCE TO RELATED APPLICATION

This application claims priority to, and the benefit of, U.S. Provisional Patent Application No. 63/774,258 filed on Mar. 19, 2025, the teachings of which are hereby incorporated by reference.

### TECHNICAL FIELD

The present disclosure relates to Internet security, and more particularly to detecting command and control (C2) attacks using domain name system (DNS) servers.

### BACKGROUND

The resourcefulness of greedy, dastardly blackguards knows few bounds, and many will seek to install “malware” within a computer system. The term “malware” is a contraction of “malicious software” which, as its name suggests, is intrusive software that is intended to achieve a malevolent end, such as exfiltration of data, surveillance, or commandeering a computer system. Malefactors seek to install malware by a variety of techniques, such as manipulating a user into clicking a link or opening an e-mail attachment that will result in installation of the malware on the user's computer system, among other attack vectors. Once installed, certain types of malware will communicate surreptitiously with a server controlled by the malefactor. The data exchanged between the installed malware and the malefactor server is referred to as “command and control” data or “C2” data.

One specific way of attacking is through a domain name system (DNS) server. The domain name system allows a domain name to be translated to the relevant IP address for the requested website. A first computer may seek to access a website, such as http://www.example.com, via a web browser. This first computer lacks information about the IP address for http://www.example.com and will send a request (a “DNS query”) to a DNS server seeking the corresponding IP address. The request may propagate through multiple DNS servers. For example, the first computer may send a DNS request to a type of DNS server called a DNS resolver. If the DNS resolver does not have the IP address for the requested domain name, the DNS resolver will send a DNS query to a root DNS server. The root DNS servers maintain the locations of the top-level domains (TLDs), such as .com. While the root DNS server may not have the specific IP address for http://www.example.com, the root DNS server can provide the DNS resolver with the location of the DNS servers for the .com TLD. The DNS resolver can then send a DNS query to the .com TLD DNS servers, which will locate the authoritative DNS server for http://www.example.com and provide the DNS resolver with the identity of that authoritative DNS server. The DNS resolver can then query the authoritative DNS server, which can then return the IP address for http://www.example.com to the DNS resolver, which can then provide that IP address to the first computer.

Since DNS queries are ubiquitous within Internet traffic and are typically subject to little or no security control, they provide an inviting channel for C2 communication. The attackers can exploit the lack of security associated with DNS queries to exfiltrate data or execute commands on infected assets. An infected computer asset will use DNS queries to exfiltrate data by sending text through DNS queries that will reach the malicious control center. Detecting such traffic is extremely challenging, and attackers can further obfuscate their activities by encoding (e.g. encrypting) the text contained within the DNS queries.

### SUMMARY

In one aspect, a computer-implemented method for detecting a potential C2 channel traversing a DNS server comprises, for each DNS query in a plurality of DNS queries directed to a DNS server outside of a network: examining the DNS query, and classifying the DNS query as one of (a) benign or (b) potentially malicious. Classifying the DNS query as potentially malicious is based upon detection of at least one encoded segment within the DNS query.

In some embodiments, the method further comprises comparing a number of the potentially malicious DNS queries emanating from a particular single host for a particular single domain to a threshold and, responsive to the number of the potentially malicious DNS queries emanating from the particular single host for the particular single domain satisfying the threshold, flagging the particular single host as a potentially infected host. In some such embodiments, the particular single domain is a root domain in combination with all subdomains thereof. In other such embodiments, the particular single domain is a root domain in combination with at least one individual subdomain. In still other such embodiments, the particular single domain is a root domain alone.

In some embodiments, the threshold is a heuristically determined threshold.

In some embodiments, the method may further comprise reclassifying the DNS query from potentially malicious to benign where, for a totality of DNS queries having a common root domain with the DNS query, there are fewer than a minimum number of DNS queries having subdomains that include an encoded segment.

In some embodiments, the plurality of DNS queries directed to a DNS server outside of the network is obtained by filtering to eliminate low risk DNS queries.

In preferred embodiments, detection of the at least one encoded segment within the DNS query is performed by a trained machine learning engine. The trained machine learning engine is preferably a neural network, more preferably a recurrent neural network (RNN), and still more preferably a Long Short-Term Memory (LSTM) network.

In some embodiments, the at least one encoded segment is encrypted.

In another aspect, the present disclosure is directed to a computer-implemented method of training a machine learning engine to identify an encoded segment within a DNS query. The method comprises generating a plurality of synthetic benign substrings, wherein the benign substrings are generated by concatenating a plurality of dictionary words, generating a plurality of synthetic encoded substrings, wherein the encoded substrings are generated by applying encoding to unencoded character strings, and training the machine learning engine to distinguish between the benign substrings and the encoded substrings.

In preferred embodiments, at least one of (a) the benign substrings and (b) the encoded substrings include added noise. In some such embodiments, the noise comprises at least one of randomly selected numbers, randomly selected special characters, and randomly selected letters.

In some embodiments, the unencoded character strings comprise additional dictionary words.

In some embodiments, the unencoded character strings are drawn from the benign substrings.

The encoding may be encryption.

In a further aspect, the present disclosure is directed to a computer program product comprising at least one tangible computer readable medium embodying instructions which, when executed by a data processing system, cause the data processing system to implement any of the above-described methods.

In a still further aspect, the present disclosure is directed to a data processing system comprising memory and at least one processor, wherein the memory contains instructions which, when executed by the at least one processor, cause the at least one processor to implement any of the above-described methods.

### BRIEF DESCRIPTION OF THE DRAWINGS

These and other features will become more apparent from the following description in which reference is made to the appended drawings wherein:

FIG. 1 shows an illustrative computer network in respect of which aspects of the present disclosure may be implemented;

FIG. 2 depicts an example embodiment of a server in a data center;

FIG. 3 is a flow chart showing, at a high level, an illustrative non-limiting embodiment of a method for detecting a potential C2 channel traversing a DNS server according to an aspect of the present disclosure;

FIG. 4 shows a first illustrative non-limiting implementation of the method of FIG. 3;

FIG. 5 shows a second illustrative non-limiting implementation of the method of FIG. 3:

FIG. 6 is a flow chart showing an illustrative method of training a machine learning engine to identify an encoded segment within a DNS query, according to an aspect of the present disclosure;

FIG. 7 is a schematic representation of an illustrative, non-limiting method for generating a plurality of synthetic benign substrings by concatenating a plurality of dictionary words, according to an aspect of the present disclosure; and

FIG. 8 is a schematic representation of an illustrative, non-limiting method for generating a plurality of synthetic encoded substrings by applying encoding to unencoded character strings, according to an aspect of the present disclosure.

### DETAILED DESCRIPTION

DNS queries have constraints on what may be passed to the DNS resolver, such as the size of the queries and the type of characters that may be passed into the query. Due to this limitation, the infected computer will have to send large numbers of queries to exfiltrate data. The attacker will also often attempt to encrypt the data so that system administrators will not be able to parse what is being sent. Moreover, in a typical infection scenario, the encrypted texts within these DNS queries will be sent from a limited number of hosts (i.e. servers). The present disclosure describes the practical application of these insights to detect a potential C2 channel traversing a DNS server.

Broadly speaking, the systems, methods and computer program products of the present disclosure classify DNS queries as either benign or potentially malicious, where a classification as potentially malicious occurs where at least part of the DNS query is suspected to be encoded (e.g. encrypted). Preferably the classification of the DNS queries is performed by a trained machine learning engine. Empirical rule-based heuristics can be applied, both in respect of the DNS queries as a whole, and in respect of the DNS queries that include suspected encoding. For example, a rule-based heuristic can be applied to the DNS queries as a whole to eliminate DNS queries for domains that were visited by more than a minimum number of individual hosts within a specified time period, so as to reduce the number of DNS queries to which the machine learning engine must be applied. Another rule-based heuristic compares the number of potentially malicious DNS queries emanating from a particular single host for a particular single domain to a threshold to assess whether the host is potentially infected. A method for training the machine learning engine is also described, in which a training set is composed of a benign class that includes noise, and a positive class that includes encrypted data and noise.

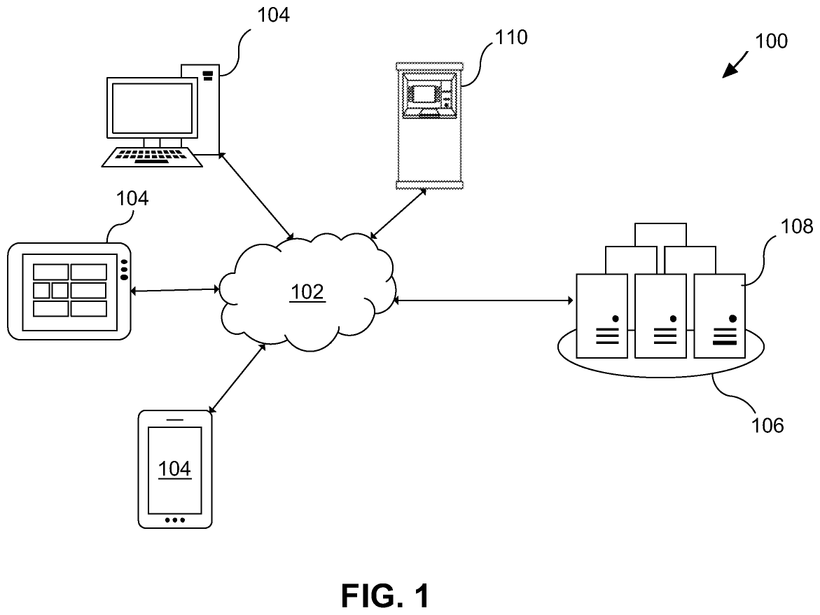

Referring now to FIG. 1, there is shown a computer network 100 that comprises an example embodiment of a system for conducting electronic financial transactions. More particularly, the computer network 100 comprises a wide area network 102 such as the Internet to which various client devices 104, an ATM 110, and data center 106 are communicatively coupled. The data center 106 comprises a number of servers 108 networked together to collectively perform various computing functions. For example, in the context of a financial institution such as a bank, the data center 106 may host online banking services that permit users to log in to those servers using user accounts that give them access to various computer-implemented banking services, such as online fund transfers. Furthermore, individuals may appear in person at the ATM 110 to withdraw money from bank accounts controlled by the data center 106. This is merely an illustrative embodiment of a computer network, and is not limiting.

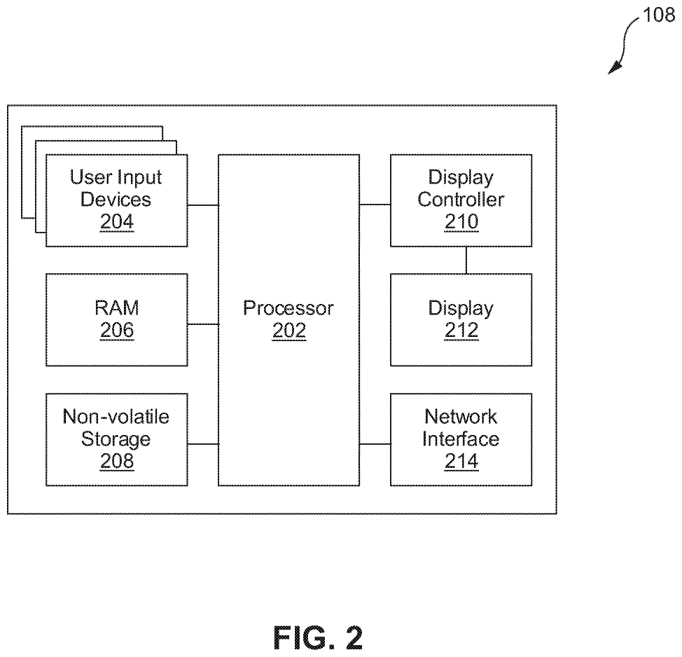

Referring now to FIG. 2, there is depicted an example embodiment of one of the servers 108 that comprises the data center 106. The server comprises a processor 202 that controls the overall operation of the server 108. The processor 202 is communicatively coupled to and controls several subsystems. These subsystems comprise user input devices 204, which may comprise, for example, any one or more of a keyboard, mouse, touch screen, voice control; random access memory (“RAM”) 206, which stores computer program code for execution at runtime by the processor 202; non-volatile storage 208, which stores the computer program code loaded into the RAM 206 at runtime; a display controller 210, which is communicatively coupled to and controls a display 212; and a network interface 214, which facilitates network communications with the wide area network 102 and the other servers 108 in the data center 106. The non-volatile storage 208 has stored on it computer program code that is loaded into the RAM 206 at runtime and that is executable by the processor 202. When the computer program code is executed by the processor 202, the processor 202 causes the server 108 to implement aspects of a method for detecting a C2 attack on a DNS server. Additionally or alternatively, the servers 108 may collectively perform that method using distributed computing, or may cooperate with one or more cloud computing environments to do so. While the system depicted in FIG. 2 is described specifically in respect of one of the servers 108, analogous versions of the system may also be used for the client devices 104.

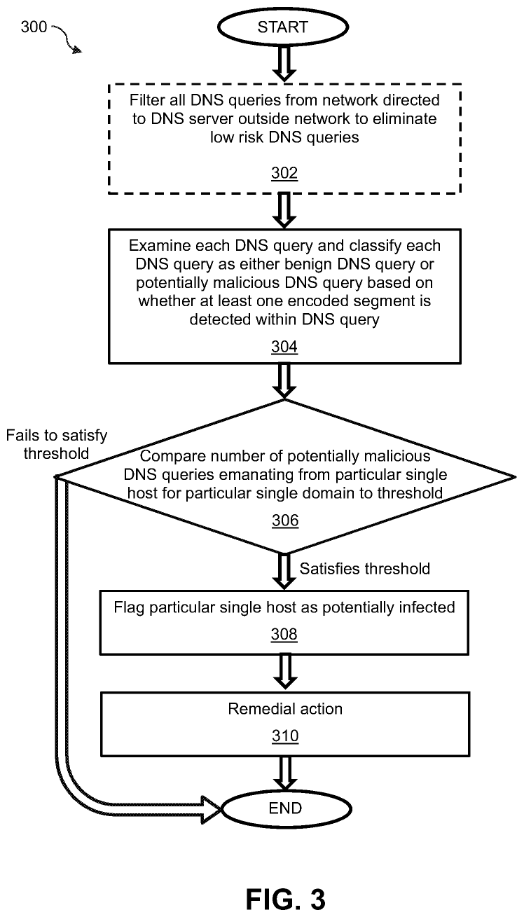

Reference is now made to FIG. 3, which shows, at a high level, an illustrative non-limiting embodiment of a method 300 for detecting a potential C2 channel traversing a DNS server. In a preferred embodiment, the method 300 is carried out in respect of a particular network (e.g. the data center 106), which may be a secure network with boundaries such as hardware and/or software firewalls interposed between that network and other networks that are external thereto (e.g. the Internet).

At optional step 302, the method 300 filters all of the DNS queries from the network that are directed to a DNS server outside of the network to eliminate low risk DNS queries and thereby obtain a plurality of DNS queries directed to a DNS server outside of the network which omits the low-risk DNS queries.

At step 304, the method 300 examines each DNS query in the plurality of DNS queries and classifies each DNS query as either a benign DNS query or a potentially malicious DNS query. Classifying the DNS query as potentially malicious is based upon detection of at least one encoded segment within the DNS query, for example a segment encoded using encryption. The term “encoding” refers to a reversible transformation of data from one format to another using a publicly available scheme, and “encryption” is a type of secure encoding that requires a specific key to reverse. This may be a symmetric key arrangement, in which the same key will both encode and decode the data, or a public/private key arrangement in which a public key can be used to encode the data, but a different, private key is required to decode it. At optional step 306, the method 300 compares the number of potentially malicious DNS queries emanating from a particular single host (a computer with a unique IP address, e.g. a server) for a particular single domain to a threshold and, responsive to the threshold being satisfied, flags that particular single host as a potentially infected host at step 308. Otherwise, where the number of potentially malicious DNS queries emanating from the particular single host for a particular single domain fails to satisfy the threshold, the method ends after step 306. Where a particular single host is flagged as a potentially infected host, remedial action may be undertaken at step 310. For example, security personnel may be alerted to investigate the potentially infected host, or the potentially infected host may be quarantined (i.e. further communication to and from the potentially infected host may be restricted or blocked). Optionally, steps 306, and, if applicable, steps 308 and 310 may be carried out for a plurality of individual single hosts, for example for each host in the network.

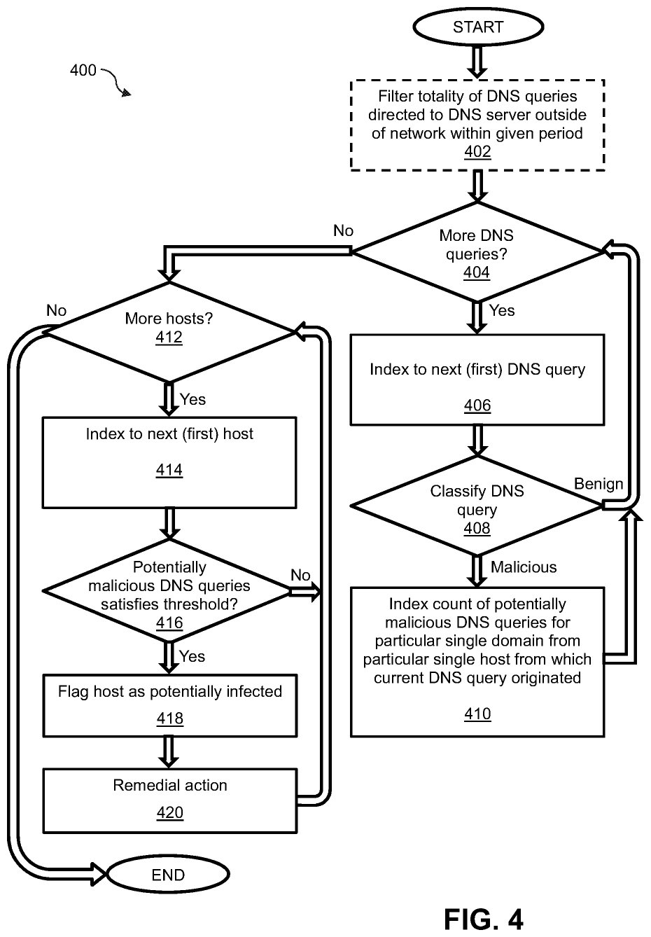

Reference is now made to FIG. 4, which shows a first illustrative non-limiting implementation, denoted by reference 400, of the method 300 for detecting a potential C2 channel traversing a DNS server.

At optional step 402, the method 400 filters the totality of DNS queries directed to a DNS server outside of the network within a given period (e.g. one hour, or twelve hours, or one day) to eliminate low risk DNS queries and thereby obtain the plurality of DNS queries to be examined. For example, where the number of discrete individual hosts (computers having a distinct IP address, e.g. a server) emitting DNS queries for the same complete URL exceeds a threshold (e.g. 10 discrete individual hosts, or 20 discrete individual hosts), those DNS queries may be eliminated. The reasoning is that these DNS queries are most likely benign because they are visited by more than a threshold number of discrete individual hosts. This is because it is rare for encoded messages to be sent by multiple discrete individual hosts. Of note, the filtering at optional step 402 is applied to the entire DNS query. Thus, where “instance.example.com” is a popular DNS query for which the total number satisfies the threshold, the DNS queries for “instance.example.com” may be eliminated from further consideration, but a DNS query for (e.g.) “fjsdhfd83dfd.instance.example.com” would be retained within the plurality of DNS queries to be (further) examined. The threshold may be an empirical threshold. The threshold may be a heuristic threshold. The use of a threshold is merely one illustrative implementation of filtering, and is not limiting. For example, a whitelist of benign DNS queries may be used as an alternative to, or in addition to, a threshold number of identical DNS queries from discrete individual hosts.

At step 404, the method 400 checks whether there are more DNS queries to examine and classify and, if so (“yes” at step 404) the method 400 proceeds to step 406. If all DNS queries have been examined and classified (“no” at step 404), the method 400 proceeds to step 412, as described further below.

At step 406, the method 400 indexes to the next (or first) DNS query directed to a DNS server outside of the network and then proceeds to step 408. At step 408, the method 400 classifies the current DNS query as one of (a) benign or (b) potentially malicious. The DNS query is classified as potentially malicious based upon detection of at least one encoded segment within the DNS query. The detected encoding may be, for example, encryption. In a preferred embodiment, detection of the encoded segment(s) within the DNS query is performed by a trained machine learning engine. The use of a machine learning engine is preferred because deep learning is more flexible than rule-based algorithms. In a particularly preferred embodiment, the trained machine learning engine is a neural network. In an even more particularly preferred embodiment, the neural network is a recurrent neural network (RNN). A currently most preferred embodiment has the RNN in the form of a Long Short-Term Memory (LSTM) network, although this is not intended to be limiting. LSTM is a modification to an RNN that allows for better performance through “forget” and “memory” gates that help alleviate the “vanishing gradient problem” associated with RNN architecture. Without being limited by theory and without promising any particular utility, this may allow the resulting the model to have high accuracy while mitigating false positives.

Responsive to classifying the current DNS query as benign (“benign” at step 408) the method 400 returns to step 404 to check for more DNS queries.

However, responsive to classifying the current DNS query as potentially malicious (“malicious” at step 408), the method 400 proceeds to step 410 to index the count of potentially malicious DNS queries for the relevant particular single domain from the particular single host from which the current DNS query originated. Then, from step 410, the method 400 returns to step 404 to check for more DNS queries.

After all of the DNS queries have been examined and classified, (“no” at step 404), the method 400 proceeds to step 412 to begin a process of evaluating whether any particular single host(s) may be potentially infected. At step 412, the method 400 checks whether there are any more hosts to evaluate, and if so (“yes” at step 412), the method 400 proceeds to step 414 to index to the next (first) host, and then proceeds to step 416. If there are no more hosts to check (“no” at step 412), the method 400 ends.

At step 416, the method 400 compares the count of potentially malicious DNS queries emanating from the current host (a particular single host) for a particular single domain to a threshold. Preferably, the threshold is a heuristically determined threshold although the threshold may be determined using other suitable techniques. If the threshold is satisfied (“yes” at step 416), this indicates that the current host is potentially infected. The method 400 therefore proceeds to step 418 to flag the host as potentially infected, and then returns to step 412 to check for more hosts. If the threshold is not satisfied (“no” at step 416), this indicates that the current host is not infected and the method 400 proceeds directly back to step 412, bypassing step 418. Thus, the method 400 ends after all hosts in the network have been evaluated and any potentially infected hosts have been flagged. For a particular single host that is flagged as a potentially infected host at step 418, at step 420 remedial action, such as alerting security personnel and/or quarantining the potentially infected host, may be undertaken.

The method 400 shown in FIG. 4 examines and classifies all of the DNS queries, and then evaluates whether any particular single host(s) may be potentially infected based on the number of potentially malicious DNS queries emanating from each particular single host(s). In other embodiments, individual hosts may be evaluated.

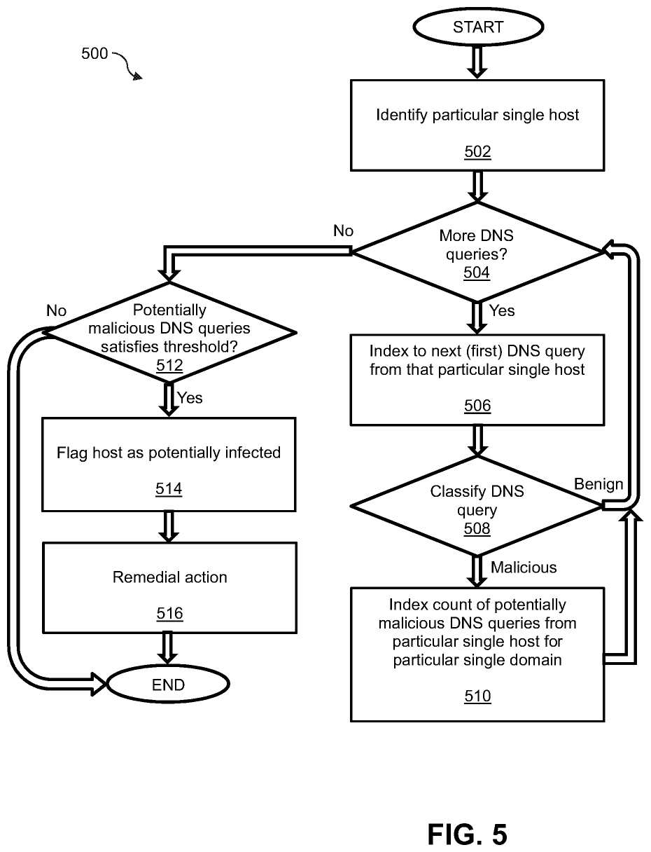

Reference is now made to FIG. 5, which shows a second illustrative non-limiting implementation, denoted by reference 500, of the method 300 for detecting a potential C2 channel traversing a DNS server. At step 502, the method 500 identifies a particular single host (e.g. server), and then at step 504 the method 500 checks whether there are any (more) DNS queries emanating from that particular single host and directed to a DNS server outside of the network. If so (“yes” at step 504), the method 500 proceeds to step 506 and indexes to the next (or first) DNS query emanating from that particular single host and directed to a DNS server outside of the network, and then proceeds to step 508. Otherwise (“no” at step 504), the method 500 proceeds to step 512 as described further below.

At step 508, the method 500 examines and classifies the current DNS query as one of (a) benign or (b) potentially malicious. The DNS query is classified as potentially malicious based upon detection of at least one encoded segment, for example encryption, within the DNS query. In a preferred embodiment, detection of the encoded segment(s) within the DNS query is performed by a trained machine learning engine, preferably a neural network, more preferably a RNN and even more preferably a LSTM network, although this is not intended to be limiting.

Responsive to classifying the current DNS query as benign (“benign” at step 508) the method 500 returns to step 504 to check for more DNS queries emanating from the particular single host and directed to a DNS server outside of the network.

However, responsive to classifying the current DNS query as potentially malicious (“malicious” at step 508), the method 500 proceeds to step 510 to index a count of potentially malicious DNS queries from the particular single host, and then returns to step 504. The count that is indexed at step 510 is a count of potentially malicious DNS queries emanating from a particular single host for a particular single domain. It is contemplated, however, that in other embodiments, the count may be a count of potentially malicious DNS queries emanating from a particular single host across all domains.

After all of the DNS queries from the particular single host have been classified (“no” at step 504) the method 500 proceeds to step 512 to test whether a number of potentially malicious DNS queries emanating from the particular single host for a particular single domain satisfies a threshold. In a preferred embodiment, the threshold is a heuristically determined threshold although the threshold may be determined using other suitable techniques.

If the number of potentially malicious DNS queries from the particular single host for the particular single domain satisfies the threshold (“yes” at step 512), the method 500 proceeds to step 514 to flag the particular single host as a potentially infected host, then to step 516 for remedial action, after which the method 500 ends. As noted above, suitable remedial action includes, but is not limited to, alerting security personnel and/or quarantining the potentially infected host. If the number of potentially malicious DNS queries from the particular single host for the particular single domain fails to satisfy the threshold (“no” at step 512), the method 500 ends (without flagging the particular single host as a potentially infected host or initiating remedial action). One of ordinary skill in the art will appreciate that the method 500 may be repeated for each host within the network, or for a subset of the hosts within the network.

As noted above, in each of the illustrative methods 400 and 500, a comparison to a threshold is made for the number of the potentially malicious DNS queries emanating from a particular single host for a particular single domain. The particular single domain may be a root domain in combination with all subdomains thereof. For instance, the root domain may be “example.com” and the particular single domain my include “example.com” alone or in combination with any series of subdomain(s), such as “instance.example.com”, “instantiation.example.com”, “sample.instance.example.com”, and so on. Alternatively, the particular single domain may be a root domain in combination with at least one individual subdomain domain, such as “instance.example.com” but not “sample.example.com” or “instantiation.example.com”. In the further alternative, the particular single domain is a root domain alone, e.g. “example.com”.

An illustrative, non-limiting algorithm for examining a DNS query and classifying the DNS query as one of (a) benign or (b) potentially malicious will now be described. The algorithm may be applied after filtering to eliminate low risk DNS queries (e.g. step 302 in the method 300 in FIG. 3 or step 402 in the method 400 in FIG. 4). Broadly speaking, the algorithm comprises decomposing the DNS query into domain levels, and then identifying suspicious subdomains within the DNS query. In one embodiment, the input to the algorithm is a DNS query log, which includes the query URL, DNS resolution record(s) (e.g. A, AAAA, TXT), source IP address (i.e. the particular single host), and a timestamp, which may be represented in tabular format as follows (a portion of the source IP is obfuscated with “X”s for anonymity):

| Query URL | Type DNS | Source IP | Epoch Timestamp |
|---|---|---|---|
| instance.example.com | A | 10.XXX.XX.199 | 1733842766 |

The DNS resolution record(s) (e.g. A, AAAA, TXT) are retained, and the query URL is then decomposed into domain levels. Consider the following two hypothetical query URLs:
login.instance.example.com
d329idsdk953ou2n34.instance.example.com

Depending on the context, for these URLs the root domain may be “example.com”, or “instance.example.com”. In either case, the query URL is decomposed into subdomains as follows:

| Query URL | Subdomain 1 | Subdomain 2 | Subdomain 3 |
|---|---|---|---|
| login.instance.example.com | example | instance | login |
| d329idsdk953ou2n34.instance.example.com | example | instance | d329idsdk953ou2n34 |

A subdomain data frame can then be created as follows, using each subdomain as a substring:

Substring

example
instance
login
d329idsdk953ou2n34

Then, each substring is assessed to determine whether that substring includes an encoded segment. The assessment may evaluate whether the entire substring is encoded (i.e. the encoded segment subsumes the substring) or only part of the substring is encoded (i.e. there is an encoded segment within a larger substring). Moreover, while the illustrated embodiment uses the entire subdomain as the substring to be assessed, in other embodiments the subdomains may be further decomposed into two or more substrings.

In one embodiment, the assessment of the substring is performed by way of a prediction carried out by a trained machine learning engine, preferably a neural network, more preferably a recurrent neural network (RNN) and even more preferably a LSTM network, although this is not intended to be limiting.

By way of further illustration, application of a trained LSTM network to the subdomain data frame noted above may yield the following results:

| Substring | Prediction |
|---|---|
| example | Not encoded (benign) |
| instance | Not encoded (benign) |
| login | Not encoded (benign) |
| d329idsdk953ou2n34 | Encoded (potentially malicious) |

The prediction may then be applied to the initial list of DNS queries, and any query URLs for which there is a substring (e.g. subdomain or part thereof) that is predicted to be encoded (e.g. encrypted) will be retained. Any query URLs for which there is no substring that is predicted to be encoded will be discarded. Thus, for the above example, the query URL “d329idsdk953ou2n34.instance.example.com” will be retained in the list because the subdomain “d329idsdk953ou2n34” is predicted to contain encoding. This means that the DSN query is classified as a potentially malicious DNS query. In contrast, none of the subdomains in the query URL “login.instance.example.com” are predicted to contain encoding. This means that it is classified as a benign DNS query, and will be discarded from the list. The list of potentially malicious DNS queries can then be used to assess each particular single host.

| Query URL | Subdomain 3 | Subdomain 2 | Subdomain 3 |
|---|---|---|---|
| d329idsdk953ou2n34.instance.example.com | example | instance | d329idsdk953ou2n34 |

Optionally, where the total number of DNS queries for a particular root domain having subdomains that include an encoded segment is below a minimum number, then the DNS queries for that root domain may also be discarded. The minimum number may be determined empirically or heuristically and may be a number or a percentage, for example. A non-limiting illustrative example of a minimum number of DNS queries for a particular root domain having subdomains that include an encoded segment is 10. Thus, if there were fewer than 10 DNS queries for domains for which the root domain is “example.com” that were found to include subdomains with encoding, all DNS queries for domains for which the root domain is “example.com” may be discarded. Thus, in some embodiments a DNS query may be reclassified from potentially malicious to benign where, for a totality of DNS queries having a common root domain with the DNS query, there are fewer than a minimum number of DNS queries having subdomains that include an encoded segment.

Once the list of potentially malicious DNS queries has been established, the hostnames for the individual hosts connected to the potentially malicious DNS queries are identified using their IP addresses, and the number of potentially malicious DNS queries emanating from a particular single host (e.g. server) for a particular single domain is compared to a threshold. The particular single domain will exclude subdomains of the query URL having the encoded portion, and any subdomains below the encoded portion. Thus, for the query URL “d329idsdk953ou2n34.instance.example.com”, the particular single domain would be “instance.example.com”. Accordingly, where there were DNS queries for “drt43542n34.instance.example.com”, “d329yt80354.instance.example.com” and “bm874553ou2n3.instance.example.com”, there would be three (3) DNS queries for the particular single domain “instance.example.com”. If there were DNS queries for the URLs “instance.drt43542n34.example.com”, “sample.d329yt80354.example.com” and “bm874553ou2n3.example.com”, there would be three (3) DNS queries for the particular single (root) domain “example.com”.

In one embodiment, the threshold is 1000 potentially malicious DNS queries although this is merely illustrative and not limiting. The threshold may be determined empirically and heuristically, and may, for example, be a number, or a percentage of the DNS queries emanating from the particular single host. If the threshold is satisfied, the particular single host is flagged as a potentially infected host. The threshold may explicitly or implicitly incorporate a time interval, e.g. the number of potentially malicious DNS queries emanating from a particular single host (e.g. server) for a particular single domain within a particular time interval, such as 1 hour, or 6 hours, or 24 hours. It is also useful to know the first and last time within the timer interval that the potentially infected host emitted a potentially malicious DNS query. An illustrative format for a record of a host that is flagged as a potentially infected host is shown below.

| Field Name | Data Type | Meaning |
|---|---|---|
| Device_ID | String | The identifier for the potentially infected |
| | | host |
| Domain | String | The domain suspected of C2 behaviour |
| Type_DNS | String | Record type of DNS queries |
| IP_type | String | Where this device is from (e.g. local |
| | | asset, cloud, Dynamic Host Configuration |
| | | Protocol (DHCP), VPN, etc.) |
| First_Seen | date | When the device first emitted the |
| | | potentially malicious DNS queries within |
| | | the specified time interval |
| Last_Seen | Date | When the device last emitted the |
| | | potentially malicious DNS queries within |
| | | the specified time interval |
| Time_Span_Hours | float | States how many hours the device has |
| | | been emitting the potentially malicious |
| | | DNS queries within the specified time |
| | | interval |
| Unique_Suspicious_Visits | Integer | States how many suspicious queries were |
| | | sent by the device to the domain |
| Queries | Array | An array of DNS queries containing |
| | | encoded segments sent from device |
| | | (optionally size is limited, e.g. to 10) |
| UUID | String | Unique identifier for event |

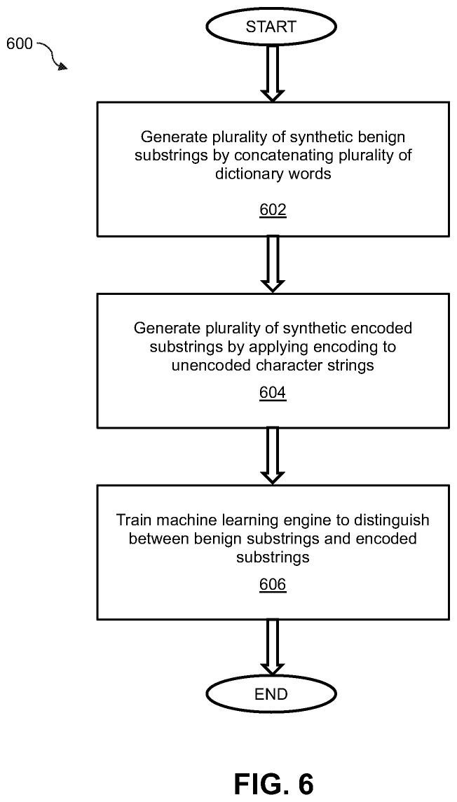

Reference is now made to FIG. 6, which is a flow chart showing an illustrative method of training a machine learning engine to identify an encoded segment within a DNS query. At step 602, the method 600 generates a benign (negative) class by generating a plurality of synthetic benign substrings. The benign substrings are generated by concatenating a plurality of dictionary words. For example, the dictionary words “bereft” and “osmosis” may be concatenated to form the non-dictionary term “bereftosmosis”. As used in this context, the term “concatenating” includes truncating. For example, concatenating the dictionary words “bereft” and “osmosis” may include truncation of “bereft” to “ber” and “osmosis” to “mosis” to produce the non-dictionary term “bermosis”. Also optionally, generating the benign class of synthetic DNS queries may include adding noise to the benign substrings. Preferably, the noise is in the form of at least one of randomly selected numbers (e.g. the numbers 0 to 9), randomly selected special characters (e.g. “-”, “@”, “$”, “!”), and randomly selected letters (A to Z) added at the beginning or end of one or more of the concatenated words. For example, if the dictionary words “bereft” and “osmosis” are concatenated to the non-dictionary term “bereftosmosis” and noise is added, the result might be “14bereft?osmosis #” or “ber-14&mosis21”. Again, these are merely illustrative, non-limiting examples.

At step 604, the method 600 generates an encoded (positive) class by generating a plurality of synthetic encoded substrings. The encoded substrings are generated by applying encoding to unencoded character strings. The encoding may, for example, be Base32 or Base64 encoding. The encoding may be encryption, for example, and without limitation, the encryption may be SHA256 encryption. Other types of encoding may also be used. The unencoded character strings may be additional dictionary words and/or may be drawn from the benign substrings and/or from another source. Optionally, but preferably, generating the encoded substrings may include adding noise. Preferably, the noise is in the form of random strings comprising at least one of randomly selected numbers (e.g. the numbers 0 to 9), randomly selected special characters (e.g. “-”, “@”, “$”, “!”), and randomly selected letters (e.g. A to Z) at the beginning and/or the end of the encoded substring.

In the context of steps 602 and 604, a “dictionary word” is an English word that uses letters from the 26-letter English alphabet and appears within a dictionary of the English language, such as one of the variations of the Oxford English Dictionary, or an online dictionary, among others, and which conveys meaning. The term “dictionary word” includes archaic words, words currently in use, and newly developed words, and also includes slang terms. Non-limiting examples of dictionary words include “harebrained”, “poniard”, “scooter”, “plenipotentiary” and the slang terms “pwned”, “riz” and “ponky”, whereas neither “hgflug” nor “trdfas” are considered “dictionary words”. The foregoing are merely illustrative examples.

Of note, the term “encoding” refers to mathematical or schematic encoding—in a broad sense a dictionary word will necessarily code for at least one particular meaning, but this is not encompassed within the meaning of the term “encoding” as used in this document. Depending on the particular implementation, steps 602 and 604 may be performed in reverse order, or substantially simultaneously.

At step 606, the method 600 trains the machine learning engine to distinguish between the benign substrings and the encoded substrings.

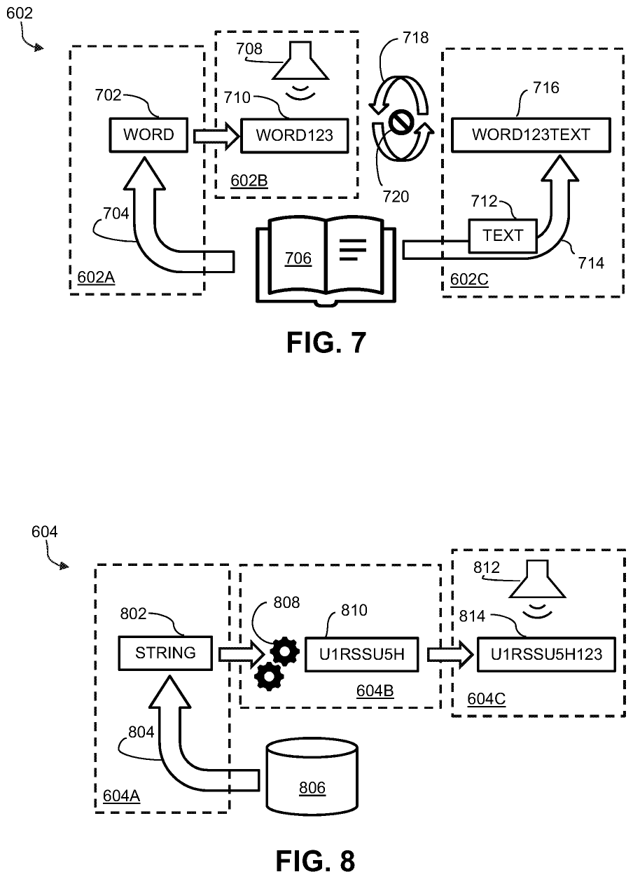

Reference is now made to FIG. 7, which is a schematic representation of an illustrative, non-limiting implementation of step 602 of the method 600 in FIG. 6, that is, generating a plurality of synthetic benign substrings by concatenating a plurality of dictionary words. At step 602A, a first word 702 is randomly selected 704 from a digital dictionary 706. At step 602B, random noise 708 is randomly added to the word 702 to produce a noised word 710. In some embodiments, the random noise 708 is added only at the beginning and/or the end of the word 702; in other embodiments the random noise 708 may also be added within the word 702, that is, at the beginning, in the middle and/or at the end of the word 702. In some embodiments, the added noise at step 602B is permitted to be null (i.e. adding random noise may include occasions on which no noise is added). At step 602C a subsequent word 712 is randomly selected 714 from the digital dictionary 706 and appended to the noised word 710 to produce a noised concatenated word string 716. In some embodiments, the subsequent word 712 may be null (i.e. on some occasions no subsequent word is added). Steps 602B and 602C may iterate 718 to add additional noise 708 and additional subsequent words 712 until a stop condition 720 is reached, at which time the resulting noised concatenated word string 716 becomes a finished benign substring and is added to the benign class. The foregoing example is illustrative, and not limiting, and variations are contemplated (e.g. including truncation).

In the embodiment shown in FIG. 7, consider a simplified scenario in which the digital dictionary contained only the words “dog”, “cat”, “cow” and “syndrome”, and the noise was selected from the digits 1 to 9 and the dash (“-”), with truncation not permitted. Possible outcomes would include (but not be limited to) “cat”, “cat-1dog”, “dogcat”, “dog-cat”, “123-dog”, “dog3434”, “dog3432cat”, and “cow-123dog-cat-syndrome”.

Reference is now made to FIG. 8, which is a schematic representation of an illustrative, non-limiting implementation of step 604 of the method 600 in FIG. 6, that is, generating a plurality of synthetic encoded substrings by applying encoding to unencoded character strings. At step 604A, an unencoded character string 802 is randomly selected 804 from a repository 806. The repository 804 may store a digital dictionary (e.g. the same digital dictionary 706 as in FIG. 7, so that the unencoded character string 802 is a dictionary word), or may store some or all of the benign substrings from step 602 in FIG. 6, or may store both of these, for example. At step 604B, randomly selected encoding 808 is then applied to the unencoded character string 802 to obtain an encoded character string 810. For example, the encoding may be randomly selected from SHA256 or other encryption, or from Base32 and Base64 encoding, among others. One of ordinary skill will recognize that, in FIG. 8, “UIRSSUSH” is the Base64 encoding of the unencoded character string “STRING”; this is merely for illustrative purposes and is not limiting. At step 604C, random noise 812 is randomly added to the encoded character string 810. In some embodiments, the random noise 812 is added only at the beginning and/or the end of the encoded character string 810; in other embodiments the random noise 812 may also be added within the encoded character string 810, that is, at the beginning, in the middle and/or at the end of the encoded character string 810. The result is a noised encoded character string 814, which is added to the encoded class as the encoded substring. In some embodiments, the added noise at step 604C is permitted to be null (i.e. no noise is added) so that the noised encoded character string 814 consists of the encoded character string 810.

As noted above, at step 606, the method 600 trains the machine learning engine to distinguish between the benign substrings and the encoded substrings. The machine learning engine is preferably a neural network, more preferably a RNN and even more preferably a LSTM network. Details of one non-limiting illustrative embodiment of a LSTM will now be provided.

The illustrative LSTM model is a stack of two layers of 512 neurons (i.e. LSTM(512)). The LSTM processes data backwards and forwards (Bidirectional). The LSTM model accepts an input shape of 100 (i.e. 100 characters). The LSTM model uses a dropout of 0.2 in between each LSTM layer, meaning that 20% of the neurons are set to 0 when training, to avoid overfitting. After the LSTM layers the model uses a dense layer that predicts the final class as either benign (represented as 0) or potentially malicious (represented as 1). The activation function for this dense layer is Softmax. The dense layer uses an activity regularizer of 0.002; the activity regularizer term will penalize large weights to avoid overfitting. The LSTM model is trained using categorical cross entropy as a loss function, with Adam as an optimization algorithm, which is used to update the weights on each iteration. An early stopping protocol is applied to the training procedure, which stops training the LSTM model if the performance on validation loss does not improve. The patience (number of epochs the model will wait for the loss to improve) is set to 1. A function to reduce learning rate upon reaching a plateau (e.g. “ReduceLROnPlateau”) will adjust the learning rate during training if the validation accuracy does not improve. In the presently described embodiment, the learning rate will be reduced by a factor of 0.1 after a patience of 2 (2 epochs of training). A lower bound is set on the learning rate (e.g. “min_delta”), and the learning rate will be reduced when the monitored metric stops increasing (e.g. mode=‘max’). An illustrative specification for this model in Keras is set out below (Keras is an API for deep learning, which is written using the Python programming language and can run atop TensorFlow, PyTorch or Jax; see https://keras.io/about/):

```
model = Sequential( )
model.add(Bidirectional(LSTM(512, return_sequences=True),
    backward_layer=LSTM(512, return_sequences=True, go_backwards=True),
    input_shape(maxlen, len_vocab)))
model.add(dropout(0.2))
model.add(Bidirectional(LSTM(512)))
model.add(dropout(0.2))
model.add(Dense(2, activity_regularizer=12(0.002)))
model.add(Activation(‘softmax’))
model.compile(loss=’categorical_crossentropy’, optimizer=’adam’,
    metrics=[‘accuracy’])
callback = EarlyStopping(monitor=‘val_loss’, patience=1)
mc = ModelCheckpoint(PATH+‘/models.h5’, monitor=‘val_loss’, mode=‘min’,
    verbose=1)
reduce_lr_acc = ReduceLROnPlateau(monitor=‘val_accuracy’, factor-0.1,
    patience=2, verbose=1, min_delta=1e-4, mode=‘max’)
```

As can be seen from the above description, the C2 channel detection technology described herein represents significantly more than merely using categories to organize, store and transmit information and organizing information through mathematical correlations. The C2 channel detection technology is in fact an improvement to the technology of Internet security, as it provides the ability to detect C2 channels traversing DNS servers. Moreover, the C2 channel detection technology is applied in respect of particular machines, namely particular individual hosts within a computer network. As such, the C2 channel detection technology is confined to Internet applications, and more specifically to computer networks from which DNS queries are sent. Improved detection of C2 channels traversing DNS servers represents a solution to a computer problem by enabling detection of malware that might otherwise escape notice. Such malware detection improves the functioning of the computer system of which the particular individual hosts form a part. Moreover, the present technology describes a specific manipulation of ordinary interactions within the Internet to yield a desired result (detection of C2 channels traversing DNS servers), overriding the routine and conventional sequence of events within Internet communication, where the DNS queries would not be subjected to the analysis and processing described in the present disclosure. Furthermore, the human mind is not equipped to detect a potential C2 channel traversing a DNS server by examining DNS queries directed to a DNS server outside of a network. Still further, the machine learning technology described herein provides an enabling technology for improved computer system functionality in respect of the detection of a potential C2 channel traversing a DNS server, and therefore is an improvement to the technology of Internet security.

The present technology may be embodied within a system, a method, a computer program product or any combination thereof. The computer program product may include a computer readable storage medium or media having computer readable program instructions thereon for causing a processor to carry out aspects of the present technology. The computer readable storage medium can be a tangible, non-transitory device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object-oriented programming language or a conventional procedural programming language. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to implement aspects of the present technology.

Aspects of the present technology have been described above with reference to flowchart illustrations and/or block diagrams of methods, apparatus (systems) and computer program products according to various embodiments. In this regard, the flowchart and block diagrams in the Figures illustrate the architecture, functionality, and operation of possible implementations of systems, methods and computer program products according to various embodiments of the present technology. For instance, each block in the flowchart or block diagrams may represent a module, segment, or portion of instructions, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Some specific examples of the foregoing may have been noted above but any such noted examples are not necessarily the only such examples. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer readable program instructions may also be stored in a computer readable storage medium that can direct a computer, other programmable data processing apparatus, or other devices to function in a particular manner, such that the instructions stored in the computer readable storage medium produce an article of manufacture including instructions which implement aspects of the functions/acts specified in the flowchart and/or block diagram block or blocks. The computer readable program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

One or more currently preferred embodiments have been described by way of example. It will be apparent to persons skilled in the art that a number of variations and modifications can be made without departing from the scope of the claims. In construing the claims, it is to be understood that the use of a computer to implement the embodiments described herein is essential.

What is claimed is:

1. A computer-implemented method for detecting a potential C2 channel traversing a domain name system (DNS) server, the method comprising:
for each DNS query in a plurality of DNS queries directed to a DNS server outside of a network:
examining the DNS query; and
classifying the DNS query as one of (a) benign or (b) potentially malicious;
wherein classifying the DNS query as potentially malicious is based upon detection of at least one encoded segment within the DNS query.

2. The method of claim 1, further comprising:
comparing a number of the potentially malicious DNS queries emanating from a particular single host for a particular single domain to a threshold; and
responsive to the number of the potentially malicious DNS queries emanating from the particular single host for the particular single domain satisfying the threshold, flagging the particular single host as a potentially infected host.

3. The method of claim 2, wherein the particular single domain is a root domain in combination with all subdomains thereof.

4. The method of claim 2, wherein the particular single domain is a root domain in combination with at least one individual subdomain.

5. The method of claim 2, wherein the particular single domain is a root domain alone.

6. The method of claim 2, wherein the threshold is a heuristically determined threshold.

7. The method of claim 1, further comprising reclassifying the DNS query from potentially malicious to benign where, for a totality of DNS queries having a common root domain with the DNS query, there are fewer than a minimum number of DNS queries having subdomains that include an encoded segment.

8. The method of claim 1, wherein the plurality of DNS queries directed to a DNS server outside of the network is obtained by filtering to eliminate low risk DNS queries.

9. The method of claim 1, wherein detection of the at least one encoded segment within the DNS query is performed by a trained machine learning engine.

10. The method of claim 9, wherein the trained machine learning engine is a neural network.

11. The method of claim 1, wherein the at least one encoded segment is encrypted.

12. A computer program product comprising at least one tangible computer readable medium embodying instructions which, when executed by a data processing system, cause the data processing system to implement the method of claim 1.

13. A data processing system comprising memory and at least one processor, wherein the memory contains instructions which, when executed by the at least one processor, cause the at least one processor to implement the method of any one of claim 1.

14. A computer-implemented method of training a machine learning engine to identify an encoded segment within a DNS query, the method comprising:
generating a plurality of synthetic benign substrings, wherein the benign substrings are generated by concatenating a plurality of dictionary words;
generating a plurality of synthetic encoded substrings, wherein the encoded substrings are generated by applying encoding to unencoded character strings; and
training the machine learning engine to distinguish between the benign substrings and the encoded substrings.

15. The method of claim 14, wherein at least one of (a) the benign substrings and (b) the encoded substrings include added noise.

16. The method of claim 15, wherein the noise comprises at least one of randomly selected numbers, randomly selected special characters, and randomly selected letters.

17. The method of claim 14, wherein the unencoded character strings comprise additional dictionary words.

18. The method of claim 14, wherein the unencoded character strings are drawn from the benign substrings.

19. The method of claim 14, wherein the encoding is encryption.

20. A computer program product comprising at least one tangible computer readable medium embodying instructions which, when executed by a data processing system, cause the data processing system to implement the method of claim 14.

21. A data processing system comprising memory and at least one processor, wherein the memory contains instructions which, when executed by the at least one processor, cause the at least one processor to implement the method of claim 14.
